(19) United States
(12) Patent Application Publication
(10) Pub. No.: US 2014/0237202 A1
(43) Pub. Date: Aug. 21, 2014

(54) SYSTEM FOR PREVENTING DUPLICATION OF AUTONOMOUS DISTRIBUTED FILES, STORAGE DEVICE UNIT, AND DATA ACCESS METHOD

(71) Applicant: Hitachi, Ltd., Tokyo (JP)

(72) Inventors: Junji YAMAMOTO, Tokyo (JP); Hiroya MATSUBA, Tokyo (JP); Katsuto SATO, Tokyo (JP); Koichi TAKAYAMA, Tokyo (JP)

(73) Assignee: HITACHI, LTD., Tokyo (JP)

(21) Appl. No.: 14/184,128

(22) Filed: Feb. 19, 2014

(30) Foreign Application Priority Data
Feb. 19, 2013 (JP) 2013-029852

(51) Int. Cl. G06F 3/06

(52) U.S. Cl. CPC G06F 3/0641; G06F 3/0619; G06F 3/067
USPC 711/162

(57) ABSTRACT

There is provided an autonomous distributed type file system which is connected to a data reference device through a first network. The autonomous distributed type file system includes a plurality of storage device units which are mutually connected through a second network and are connected to the first network. Each of the storage device unit includes a local storage and a local controller. The local controller includes a storage directory and a duplicated data maintaining unit. The duplicated data maintaining unit refers to the storage directory, and continuously keeps same contents of duplicated data items in a range without running out of storage capacity of an own node. When there is no free space in the storage capacity, duplicate writing of the data with the same contents is prevented.

### CLAIM OF PRIORITY

The present application claims priority from Japanese Patent Application 2013-029852 filed on Feb. 19, 2013, the content of which is hereby incorporated by reference into this application.

### FIELD OF THE INVENTION

The present invention relates to an apparatus and a method, for preventing duplication of data strings of files in an autonomous distributed type file system, and, more particularly, to an effective technique applicable to controlling replicated data of a storage device which can be connected to a plurality of different kind networks.

### BACKGROUND OF THE INVENTION

With a rapid increase in an amount of data handled in a computer system, there has been developed a technique for realizing high speed access and large volume access to a storage device system. In this technique, connection is made between a plurality of disk array devices (hereinafter referred to as storage device systems) and servers using a dedicated network (Storage Area Network, hereinafter referred to as SAN), to manage enormous data with high efficiently. To realize high speed data transfer by connecting the storage device systems and the servers through the SAN, a network is generally constructed using a communication unit in accordance with a fiber channel protocol.

In general, contents that have different file names are independently stored into a storage device even if the contents are exactly same. Thus, the storage capacity is wastefully consumed. It is therefore important to attain a technique for preventing storage of files with the duplicated contents.

Japanese Unexamined Patent Application Publication No. 2009-237979 discloses a server which reduces an increased amount of data stored in a plurality of file servers and can out down a storage cost for file maintenance. In the invention of Japanese Unexamined Patent Application Publication No. 2009-237979, when a duplicated files are included in those files stored by a controlling file server, a proxy server for file server management causes a user terminal to show the files in the form of a plurality of files, on the other hand, in fact, only one file is stored, thereby attempting to reduce the duplicated file. According to this server, in response to a request for storing a file from a user terminal, a file access management unit acquires a hash value of the requested file for storage, and checks the existence of the same file based on the hash value. A file management unit manages only registration information regarding the requested file for storage if there is the same file as the requested file for storage, and manages the registration information regarding the requested file for storage and file data if there is not the same file as the requested file for storage.

Japanese Unexamined Patent Application Publication No. 2009-129441 discloses a technique for deduplicating data in a storage system, by calculating a hash value of a current virtual file, and searching for real file information based on the same hash value. In the invention of Japanese Unexamined Patent Application Publication No. 2009-129441, an attempt is made both to compress data storage in the capacity due to duplicate prevention and to realize data security. That is, duplicated real data is deleted. However, a duplicate prevention process is not performed when the duplication degree becomes equal to or greater than a threshold value. This enables to ease some problems such as the risk of loss of stored data and a decrease in reliability and performance over a plurality of target data items.

### SUMMARY OF THE INVENTION

In the field of big data, in the storage and process for data in a range from several hundred Terabytes to several hundred Petabytes, it is demanded to realize both a distributed storage system to be parallelly accessed by distributing storage device units and a duplicate prevention technique to allow storing enormous data.

Duplicate prevention performed in the conventional storage units is to reduce an amount of real data by removing a sector of the totally same contents.

In the invention of Japanese Unexamined Patent Application Publication No. 2009-237979, reduction is made in an amount of data by deleting the duplicated file. However, it loses an opportunity for performing a parallel process for accessing these data items by a plurality of user terminals.

In the invention of Japanese Unexamined Patent Application Publication No. 2009-129441, duplicated real data is deleted until the duplication degree reaches a threshold value. The amount of data is reduced due to deletion of the duplicated real data. However, it loses an opportunity for performing a parallel process for accessing these data items by a plurality of user terminals.

Accordingly, Japanese Unexamined Patent Application Publication Nos. 2009-237979 and 2009-129441 have no sufficient consideration on achieving both duplicate prevention of the same data in the file system and the parallel access process.

The main subject of the present invention is to provide an autonomous distributed type file system, a storage device, and a data access method, for achieving both prevention of excess duplication of the same data in order to increase an effective amount of data storage and a parallel access process.

The typical example of the present invention is as follows. A file system may be an autonomous distributed type file system which is connected to a data reference device through a first network, comprising: a plurality of storage device units which are mutually connected through a second network and connected to the first network; a storage directory; and a duplicated data maintaining unit, each of the storage device units includes a local storage, wherein the storage directory has a function of keeping, in relation to data to be kept, an ID of a logical block and an ID of a physical block of the local storage of each of the storage device units, a value of a link to a node ID of a same or another storage device unit, and a value of a link to the logical block ID of this node ID, and wherein the duplicated data maintaining unit refers to the storage directory, continuously keeps one real data item of the data and at least one replicated data item duplicately in a range without running out of storage capacity of each of the storage device units, and restricts or prevents writing of the replicated data when there is no free space in the storage capacity.

According to the present invention, in the file system, the duplication degree of the same data is appropriately controlled, and it is possible to realize both the prevention of the excess duplication and parallel access.

### BRIEF DESCRIPTION OF THE DRAWINGS

FIG. 1 is a block diagram illustrating an overall configuration of an autonomous distributed type file system according to a first embodiment of the present invention;

FIG. 2 is a block diagram illustrating an overall configuration of a storage device system of the first embodiment;

FIG. 3 is a diagram illustrating a configuration example of a management terminal in the first embodiment;

FIG. 4 is a schematic diagram illustrating a configuration example of a storage device unit in the first embodiment;

FIG. 5A is a diagram illustrating an example of a storage directory of one storage device unit in the first embodiment, before data writing;

FIG. 5B is a diagram illustrating an example of a storage directory in another storage device unit, corresponding to the flow of FIG. 6;

FIG. 6 is a flow chart illustrating a process, when a server transmits a request for writing data to the one storage device unit, in the first embodiment;

FIG. 7 is a flow chart illustrating a process of when a hash value is received from the one storage device unit in another storage device unit, corresponding to the flow of FIG. 6;

FIG. 8 is a flow chart illustrating a process of when data is received from the one storage device in another storage device unit, corresponding to the flow of FIG. 6;

FIG. 9 is a diagram illustrating the flow of data between the one storage device unit and another storage device unit, in the flow of FIG. 6;

FIG. 10A is a diagram illustrating an example of the storage directory in which data is being written halfway, in the first embodiment;

FIG. 10B is a diagram illustrating an example of the storage directory after data writing, in the first embodiment;

FIG. 11 is a diagram illustrating the flow of data at the simultaneous processing of data writing in two storage device units, in the flow of FIG. 6;

FIG. 12 is a diagram illustrating the flow of data at the simultaneous process of data writing in the two storage device units, in a comparative example;

FIG. 13 is a flow chart illustrating a data readout process for one storage device unit in the first embodiment;

FIG. 14 is a diagram for explaining the access for reading out data from a plurality of servers, for the one storage device unit in the first embodiment;

FIG. 15 is a flow chart illustrating a process for writing data to the one storage device unit, in a second embodiment of the present invention;

FIG. 16 is a diagram illustrating an example of the storage directory after data writing, in the second embodiment; and

FIG. 17 is a diagram for explaining the access for reading out data from a plurality of servers in one storage device unit of the second embodiment.

### MODE FOR CARRYING OUT THE INVENTION

According to a typical embodiment of the present invention, an autonomous distributed type file system which is connected to a data reference device includes a function/configuration for writing files (data strings) and preventing duplication thereof. Each of the files is a holder for keeping data or data itself that is kept, and one single file is composed of sequential record strings. In the record strings of one file, a pointer for referring to another file is embedded as a link. In the autonomous distributed type file system of the present invention, a link is set up to the same part of files (data strings) in different storage device units, that is, the same contents of real data. The file system continues to keep the entity of the real data in a range without running out of storage capacity of the corresponding storage device unit. Further, at the time of reading out data, the system reads the file contents located in the nearest position, thereby enabling to reduce the access time and parallel access. In the situation where it approximately runs out of storage capacity of the corresponding storage device unit, a link is set up to the same part of the real data, its entity (entities) is deleted therefrom, and the number of entities of the same contents is decreased. This enables to increase an amount of stored data (different data), and to maintain the efficiency of the parallel processing, without increasing the total storage capacity of the file system.

In the present invention, “data” implies data based on the write request from the data reference device, in other words, the data kept in different files. For example, it is assumed that the full text dₐₗₗ of a particular research paper is composed of title (d₁)+abstract (d₂)+body text (d₃ to d₉₈)+conclusion (d₉₉). The “data” may be each of data D₁₋₉₉ of the full text dₐₗₗ, data D₂ of the abstract (d₂), and data D₂₀₋₂₅ of a particular subject matter (d₂₀ to d₂₅) of the body text. These “data” items are kept respectively in different files. “Same data items” imply, for example, data D₂₀₋₂₅ and D′₂₀₋₂₅ of the same particular subject matter (d₂₀ to d₂₅). On the contrary, the data D₂₀₋₂₅ and the data D₃₋₉₈ of the body text including this are not the same data, and are different data.

Descriptions will now be made to details of the present invention, with reference to the drawings.

A server connected to a network will hereinafter be described by way of example, as a data reference device for the autonomous distributed type file system. However, the present invention is not limited to this, and is applicable to various terminals.

### FIRST EMBODIMENT

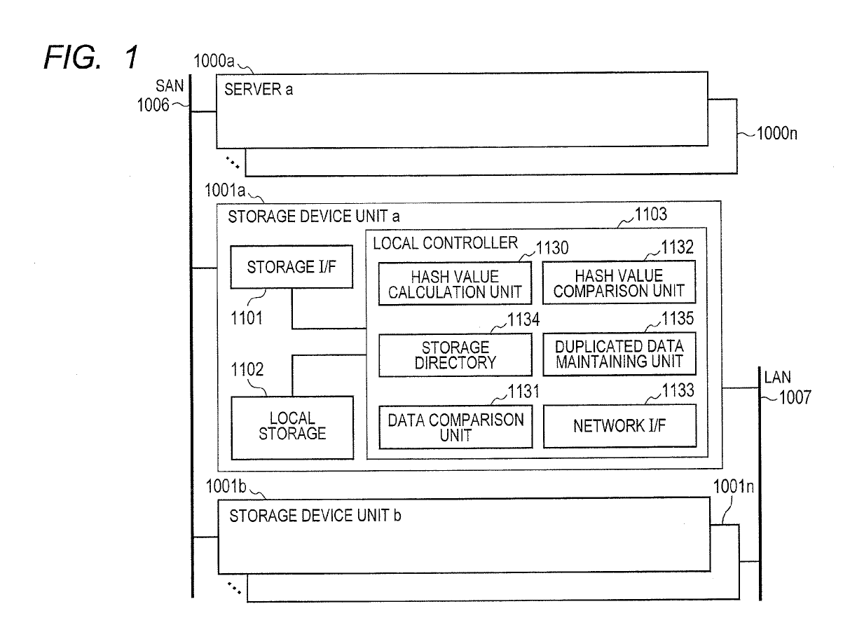

FIG. 1 is a block diagram illustrating the entire configuration of the autonomous distributed type file system according to a first embodiment of the present invention.

In the autonomous distributed type file system, a plurality of servers as data reference devices are connected through a plurality of access paths, and each of the access paths is connected to the storage device unit which stores files keeping data. That is, the plurality of servers 1000 (“a” to “n”) are connected to a plurality of autonomous distributed type storage device units 1001 (“a” to “m”), through a first network 1006. Each of the storage device units (hereinafter referred to also as nodes) 1001a to 1001n writes or reads out data of a file (data string), based on a request from each server.

The storage device units 1001 (“a” to “m”) are mutually connected through a second network 1007. The first network 106 and the second network 1007 may include, for example, an SAN, a LAN (Local Area Network), a WAN (Wide Area Network), the Internet, a public line, or a dedicated line. For example, when the network is a LAN or a WAN, the plurality of storage device units and servers are mutually connected through an NAS (Network Attached Storage), and communication is performed in accordance with a TCP/IP protocol. When the network is an SAN, communication is performed in accordance with a fiber channel protocol. In this case, the first network 1006 is configured with an SAN, while the second network 1007 is configured with a LAN.

Each of the storage device units 1001 (“a” to “m”) includes a storage interface 1101, a local storage 1102, and a local controller 1103. The local controller 1103 includes a hash value calculation unit 1130 which calculates a hash value, a data comparison unit 1131 which compares data items, a hash value comparison unit 1132 which compares hash values of data, a network interface 1133, a storage directory 1134, and a duplicated data maintaining unit 1135.

The number of storage device units 1001 (“a” to “m”), as an entire system, may be determined appropriately depending on the use. As an example, one file system is preferably configured with a plurality of storage device units 1001, that is, ten or less than ten storage device units. Each of the storage device units 1001 (“a” to “m”) is assigned a value of a unique node ID in advance. For example, the smallest ID value is given to the storage device unit 1001a, while the largest ID value is given to the storage device unit 1001n. This may be opposite to each other, or any other setting is possible. Descriptions will hereinafter be made to a case where the smallest ID value is given to the storage device unit 1001a.

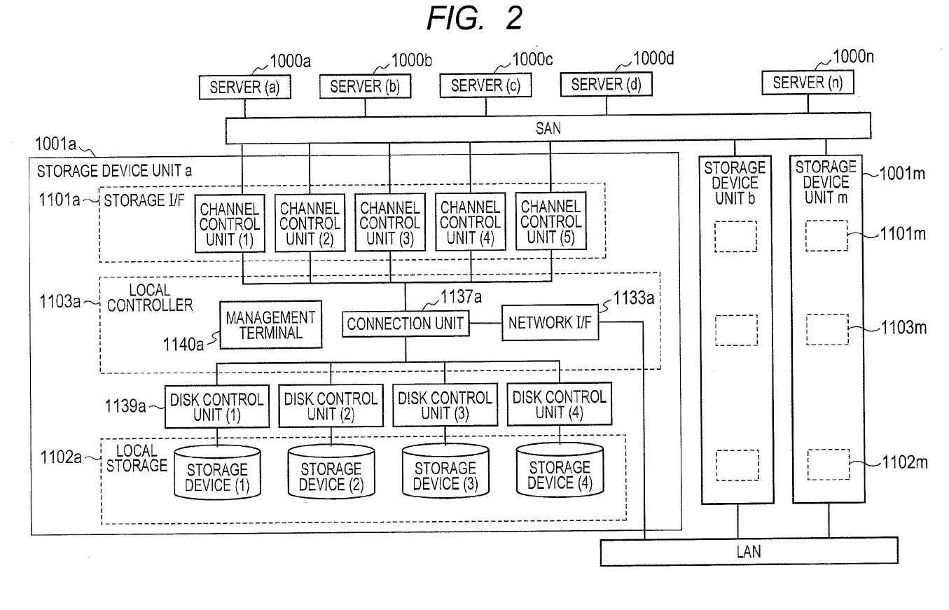

FIG. 2 is a block diagram illustrating the entire configuration of the autonomous distributed type file system including the storage device unit 1001 according to the first embodiment.

Each of the storage device units 1001 (“a” to “m”) includes channel control units 1101 (function as a storage interface), a local storage 1102, and a local controller 1103. The local controller 1103 includes a network interface 1133, a connection unit 1137, and a management terminal 1140, and controls the local storage 1102 in accordance with a command received from the servers 1000 (“a” to “n”). For example, upon reception of a data input/output request from the server 1000a, the controller performs a process for inputting/outputting data stored in the local storage 1102a. The local controller 1103a gives and receives various commands for managing its storage device unit 1001a and the interaction with each of the servers 1000 (“a” to “n”).

The channel control units 1101 are assigned respective network addresses (for example, IP addresses). The local controller 1103 receives file access requests from the server 1000 through the SAN 1006, from the channel control units 1101. The server 1000 sends a data access request (block access request) in the unit of data/blocks in accordance with a fiber channel protocol, to each of the storage device units 1001.

The local storage 1102 includes a plurality of disk drives (physical disks), and provides the server 1000 with a storage area. Data is stored in a logical volume (LU) as a storage area set logically on the physical storage area provided by the disk drive. The local storage 1102 may have a configuration of a disk array using, for example, the plurality of disk drives. In this case, the storage area provided for the server 1000 is provided using the plurality of disk drives managed by RAID (Redundant Arrays of Inexpensive Disks).

Disk control units 1139 for controlling the local storage 1102 are provided between the local controller 1103 and the local storage 1102. Data or commands are given and received between the channel control units 1101 and the disk control units 1139 through the connection unit 1137.

The disk control units 1139 write data into the local storage 1102, in accordance with a data write command which is received by the channel control unit 1101 from the server 1000. Conversion is made for a data access request for the LU based on a logical address specification transmitted by the cannel control unit 1101, into a data access request for a physical disk based on a physical address specification. When physical disks in the local storage are managed by the RAID, data accessing is performed in accordance with the RAID configuration. The disk control unit 1139 also controls to manage replicating of the data stored in the local storage 1102, as well as backup.

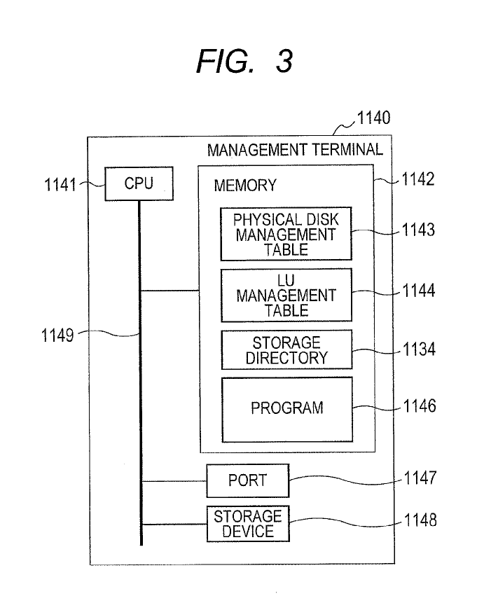

The management terminal 1140 is a computer which maintains and manages the storage device unit 1001. As illustrated in FIG. 3, the management terminal 1140 includes a CPU 1141, a memory 1142, a port 1147, a storage device 1148, a bus 1149, and an input/output device (not illustrated).

The memory 1142 stores a physical disk management table 1143, an LU management table 1144, a storage directory 1134, and a program 1146. The CPU 1141 executes the program 1146, thereby controlling the management terminal 1140 entirely.

The storage directory 1134 is to manage writing or reading of data to or from each server, for each storage device unit 1001 (“a” to “m”) in the autonomous distributed type file system, in accordance with free space of the storage device unit. The storage directories 1134 (“a” to “m”) are configured to be mutually connected with each other. Thus, the storage directory 1134 is configured to include some of functions inherent in the LU management table or the physical disk management table. That is, each of the storage directories 1134 includes some or all of the functions of the physical disk management table 1143 and the LU management table 1144, and is configured as a higher rank table than these. Alternatively, the LU management table 1144 may be omitted, and the storage directories 1134 may be provided for the storage device units in one-to-one correspondence to each other.

The physical disk management table 1143 is a table for managing the physical disks (disk drives) included in the local storage 1102. This physical disk management table 1143 records and manages disk numbers of the plurality of physical disks (included in the local storage 1102), the capacity of the physical disks, the RAID configuration, and the status of use. The LU management table 1144 is to manage the LU which is logically set on each of the physical disks. This LU management table 1144 records and manages the LU numbers of the plurality of LUs set on the local storage 1102, the physical disk numbers, the capacity, and the RAID configuration. The port 1147 is connected to an internal LAN or SAN. The storage device 1148 is, for example, a hard disk device, a flexible disk device, or a semiconductor device.

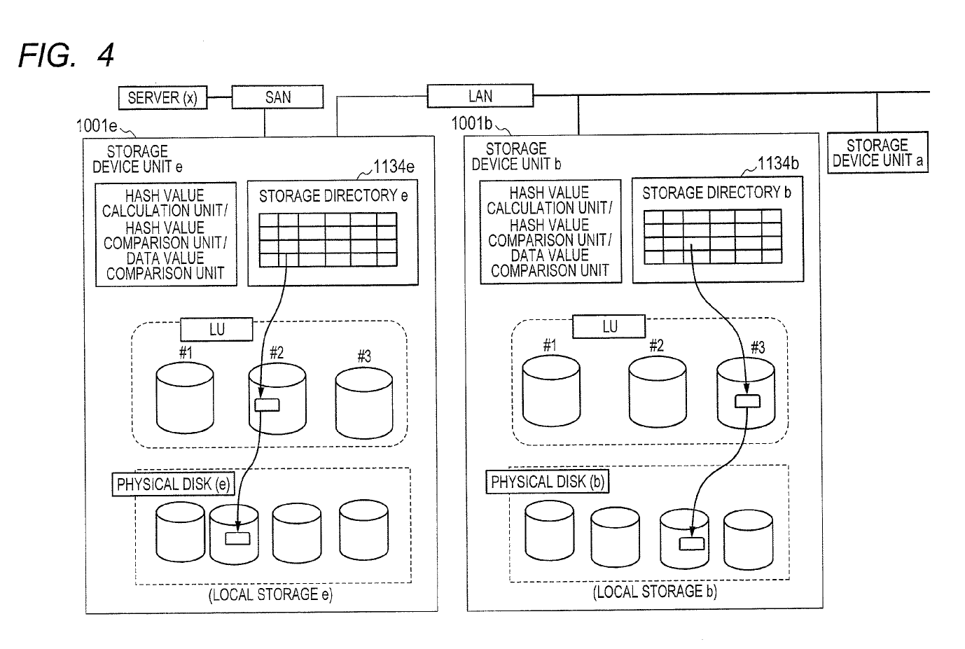

FIG. 4 is a schematic diagram illustrating a configuration of the storage device unit 1001. In the example of FIG. 4, there is one entity of a file keeping data on the physical disk of each of the storage device units 1001b and 1001e, and their addresses (logical positions) are recorded in storage directories 1134b and 1134e.

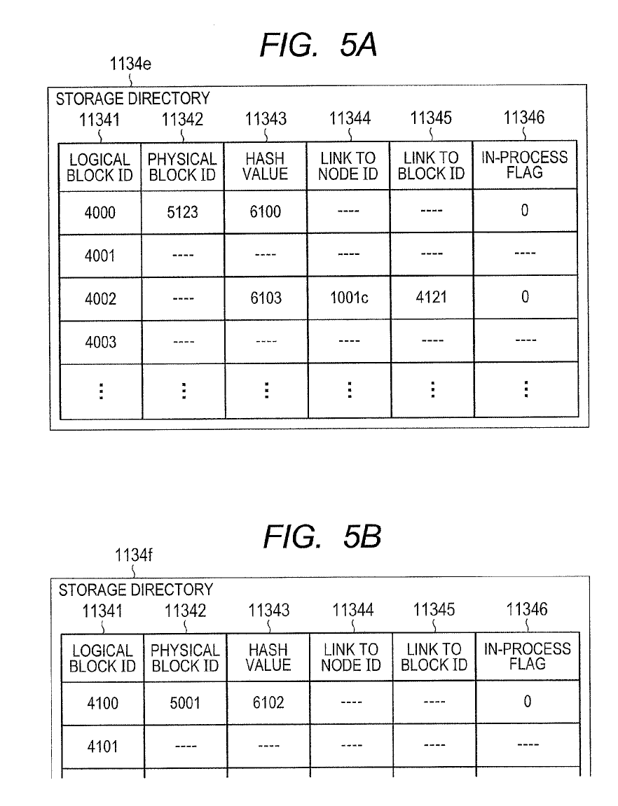

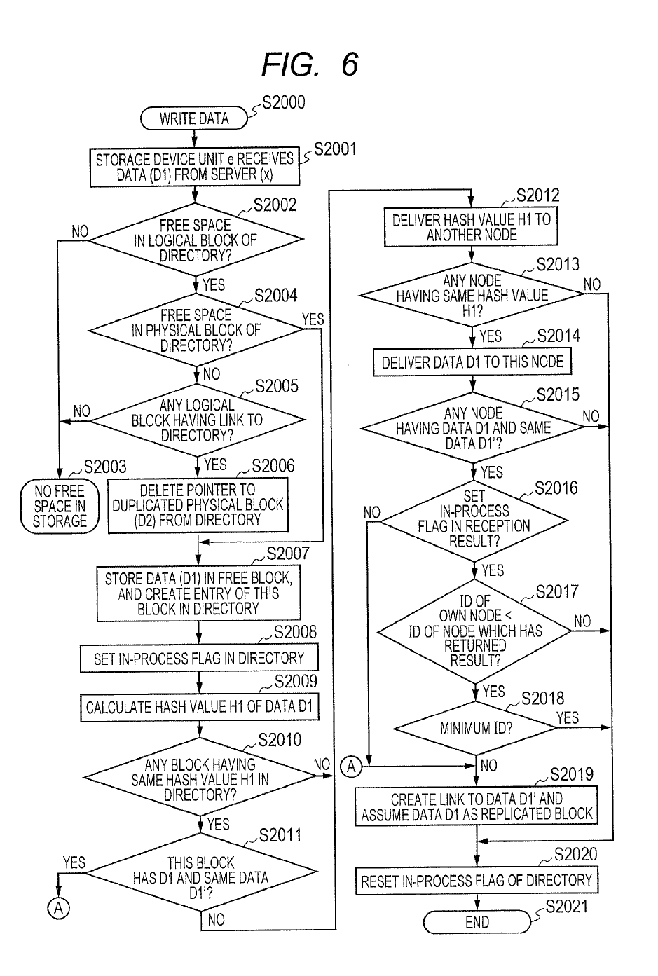

FIG. 5A is a schematic diagram illustrating a configuration example of the storage directory 113e, before writing data (FIG. 6). The storage directory 1134e is configured with six attributes, which are an ID 11341 of a logical block and an ID 11342 of physical block of data recorded in the own node, a hash value 11343 of data, a link 113444 corresponding to the recorded data, to an ID of another node(s) (storage device unit), a link 11345 to a physical block ID of another node, and an in-process flag 11346.

The logical block ID 11341 is a logical file path managed in each storage device unit 1001 (1001a to 1001m), and is uniquely set to each of all the files of the local storage. For example, logical block IDs “4000”, “4001”, “4002”, and “4003” . . . are set in the storage device unit 1001e.

The physical block ID 11342 is a real file path of a file which is actually stored in each storage device unit 1001 (1001a to 1001m). For example, in the storage device unit 1001e, “5123” is set as an ID (=4000) of a physical block in which real data of the file is stored. Each server can access the file of the storage device unit 1001, using the IDs of this storage directory 1134.

The hash value 11343 indicates a hash value (6100 or the like) of a file necessary for accessing the file. When files are duplicated, the same hash value is given. Instead of the hash value, any other feature value may be used.

The link 11344 to the node ID indicates a link to the storage device unit of another node from the storage device unit 1001 of the own node. The link 11345 to the block ID indicates a link to its logical block ID. For example, a link is set up to a logical block ID 4121 of the storage device unit 1001c, for the data of a hash value 6103, in association with the logical block ID 4002 of the storage device unit 1001e.

The in-process flag 11346 indicates whether each node is in an in-process state (=1) or not (=0).

Each of the other storage device units includes also the same storage directory 1134 as the storage device unit 1001e. FIG. 5B illustrates an example of a storage directory 1134f of a storage device unit 1001f. In the storage device unit 1001f, “4100”, “4101”, . . . are set as logical block IDs. “5001” is set as an ID of a physical block representing a stored file with a hash value 6102, in association with the logical block ID (=4100).

As an alternative of this embodiment, a management server is provided, and this server is connected to the first network and the second network of the autonomous distributed type file system. Some of functions of the local controller 1103 of each storage device unit may centrally be managed by this management server. That is, the storage directory 1134 is provided in this management server, while the physical disk management table and the LU management table are provided in each storage device unit. The logical position, data, and a feature quantity in each storage device unit 1001, at the data writing, are kept in the storage directory of the management server. In this case, at the time of data readout, the server inquires of this management server to obtain the position of the storage device unit having the data with reference to the storage directory 1134.

Descriptions will now be made to characteristic functions of the autonomous distributed type file system according to this embodiment, with reference to FIG. 4.

The local controller of the storage device units b and e includes a duplicated data maintaining unit and a calculation/comparison function of hash values and data values. In this function, when there is free space in the logical block of the local storage, in other words, unless it runs out of storage capacity, one real data item of data and at least one replicated data item are duplicated and continuously kept. When there is no free space in the logical block, in other words, if the storage capacity has no extra space, writing of replicated data is restricted or prevented. More specific descriptions will be made below.

### [Control of Writing and Duplication]

(1) Each storage device unit 1001 calculates and records a feature value (hash value or the like) of data held by the own node, in the storage directory 1134.
(2) When a server (connected to the storage) writes new data D into a logical position p (of logical/physical blocks), the storage device unit which has received the data (1001e in this example) calculates a feature value (hash value) H of the new data D, extracts data having the same hash value from a list of feature values recorded in the own node, and sets up a link to data D′ if the own node has the data D′ which is duplicated with the new data D.
(3) The storage device unit 1001e which has received the data reports the feature value (hash value) H of the new data D to another storage device unit i (hereinafter represented as the storage device unit 1001b) included in the storage system.
(4) The storage device unit b which has received the feature value selects data having the same hash value from the list of feature values recorded in the own node. The storage device unit b having the same value H′ requests the storage device unit e for data D.
(5) The storage device unit e transfers data D to the storage device unit b.
(6) The storage device unit b determines whether the own node has the same data D′ as the data D, and sends the determination result to the storage device unit e.
(7) When there is a storage device unit b having the same data D′, the storage device unit e keeps the data D as a replica of the data D′, creates a link from the data D to the data D′, and records it in the storage directory 1134e. The creation of the link to the storage device unit b implies that the data D is marked as “data that can be prevented from being duplicated” when it approximately runs out of storage capacity of the storage device unit e.

The storage directory of the storage device unit b records that the data D′ (same as the data D) held by the storage device unit b is linked from another.

### [Readout]

(1) The server (x) specifies a logical position p, and requests the storage device unit e for data D.
(2) The storage device unit e sends data D when it has the data D with the logical value p.
(3) When there is no requested data in the own node, and when there is a link to “p”, the storage device unit e requests the storage device unit b as a destination link, to transfer the data D′.
(4) The storage device unit e receives the data D′ from the storage device unit b, thereafter sending the data D′ to the server.

Descriptions will now be made to a process mainly performed by the duplicated data maintaining unit 1135, when a server writes data into one storage device unit e, with reference to FIG. 5A to FIG. 10B.

FIG. 6 is a flow chart illustrating a process (S2000) mainly performed by the duplicated data maintaining unit 1135, at the time of writing data into the storage device unit e.

Upon reception of written data (D1) from a server (x) (S2001), the storage device unit e determines whether there is free space in logical blocks of the storage directory 1134e of the own node (S2002).

If there is no free space in the logical blocks of the directory, it is assumed that “there is no free space” in the storage, and the process ends (S2003). If there is free space in the logical blocks of the directory, it is determined whether there is free space in physical blocks of the directory (S2004). If there is no free space in the physical blocks of the directory (“NO” in S2004), it is determined whether there is a logical block having a link to the directory (S2005). If there is no logical block with the link, a response of “there is no free space” is made, and the process ends (S2003). If there is a duplicated physical block (for example, a physical block “D2”) in the directory, a pointer to the physical block is deleted (S2006), and a free block is secured. Then, data (D1) is stored in this free block, an entry of this block is created in the storage directory (S2007), and an “in-process flag” is set in the storage directory (S2008).

Further, a hash value H1 of the data D1 is calculated (S2009). It is determined whether there is a block having the same hash value H1 in the storage directory of the own node (S2010). If there is a block having the same hash value H1, it is determined whether there are blocks having the same data D1′ in the storage directory of the own node (S2011). When the blocks having the same data D1′ are in different files, the flow proceeds to Step 2019, in which a link to the data D1′ is created, and the data D1 is assumed as a replicated block of the data D1′. When blocks having the same data are not in the storage directory of the own node, the hash value H1 is delivered to another node (S2012).

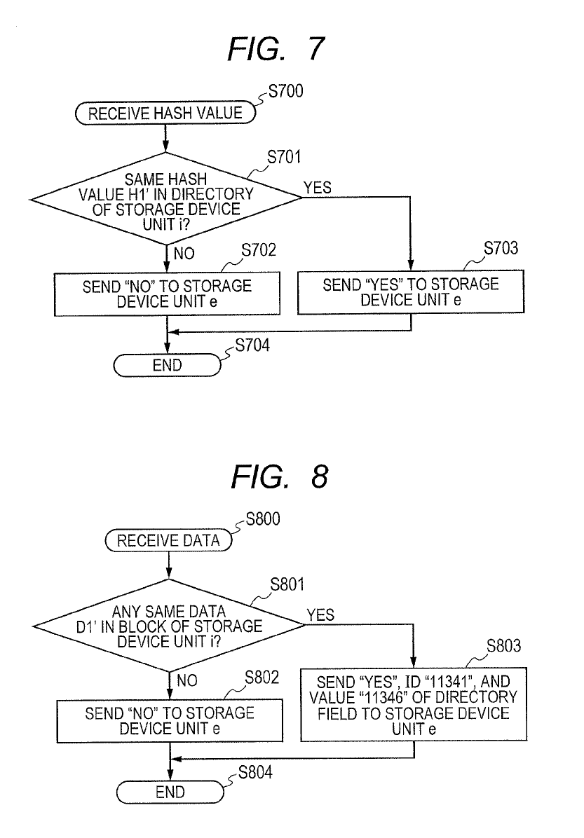

FIG. 7 is a flow chart illustrating a process at the time of receiving (S700) the hash value H1 from the storage device unit e, in another storage device unit b. Each of the storage device units i (in this case, “i”=b) determines whether the same hash value H1′ is in the storage directory of the own node (S701). If the hash value H1′ is not in the storage directory, “NO” is sent to the storage device unit e. On the contrary, if there is the same hash value, “YES” is sent to the storage device unit e, and the process ends (S702 to S704).

In FIG. 6, upon reception of a response from another node, the storage device unit e delivers the data D1 to the node, when there are nodes having the same hash value H1 (“YES” in S2013) (S2014).

FIG. 8 is a flow chart illustrating a process at the time of receiving (S800) the data D1 from the storage device unit e, in another storage device unit b. Each of the storage device units i (in this case “i”=b) determines whether the same data D1′ as D1 is in the storage directory of the own node (S801). If data D1′ is not in this storage directory, “NO” is sent to the storage device unit e. On the contrary, if there is the same data D1′, “YES” is sent thereto, and the process ends (S802 to S804). In S801, if there is the same data D1′, the “in-process flag” is set to “1” in the storage directory, and in S803, the value “1” of the “in-process flag” is sent thereto together with “YES”.

In FIG. 6, upon reception of a response from another node, the storage device unit e determines whether there are blocks having the same data (S2015). If there is one or a plurality of blocks having the same data (“YES” in S2015), it is determined whether an “in-process flag” is set in the reception result from this node (S2016). If the “in-process flag” is set, a comparison is made on the magnitude relation between the ID of the own node and an ID value corresponding to the node which has sent the result (S2017). When the ID of the own node is a small value, the flow proceeds to Step 2018. When the same data D1′ as the data D1 is in a plurality of nodes, it is determined whether the ID of the own node is the smallest value between these nodes. If the ID of the own node is not the smallest value therebetween, the flow proceeds to Step 2019. When the “in-process flag” is not set in Step 2016, the flow also proceeds to Step 2019. In Step 2019, a link is created to link to the data D1′ of the own node or the data D1′ of another node having the smaller ID than the own node, and this link is recorded in the storage directory. Then, the data D1 of the own node is assumed as a replicated block of the data D1′. On the contrary, if the ID of the own node is larger in Step 2017, or when the ID of the node is the smallest value in Step 2018, a link to the data D1′ is not created, and the flow proceeds to Step 2020, and the data D1 is stored as it is. In this manner, real data is stored in one particular node (hereinafter, a particular node) with the small ID, and a replicated block of the real data is stored in the node with a large ID, or a link (directly or indirectly) to the real data is created. A replicated block of the real data can be stored in the particular node, or a link can be created thereto. That is, procedures from Step 2017 to Step 2019 are performed for the same data, and are to realize a “function of keeping one real data item in a particular node, and keeping one or more replicas in this particular node or another node, or creating a link”. By this function, each of the storage device units can continuously keep the same data in a plurality of different files, thereby enabling to reduce the access time or perform parallel access.

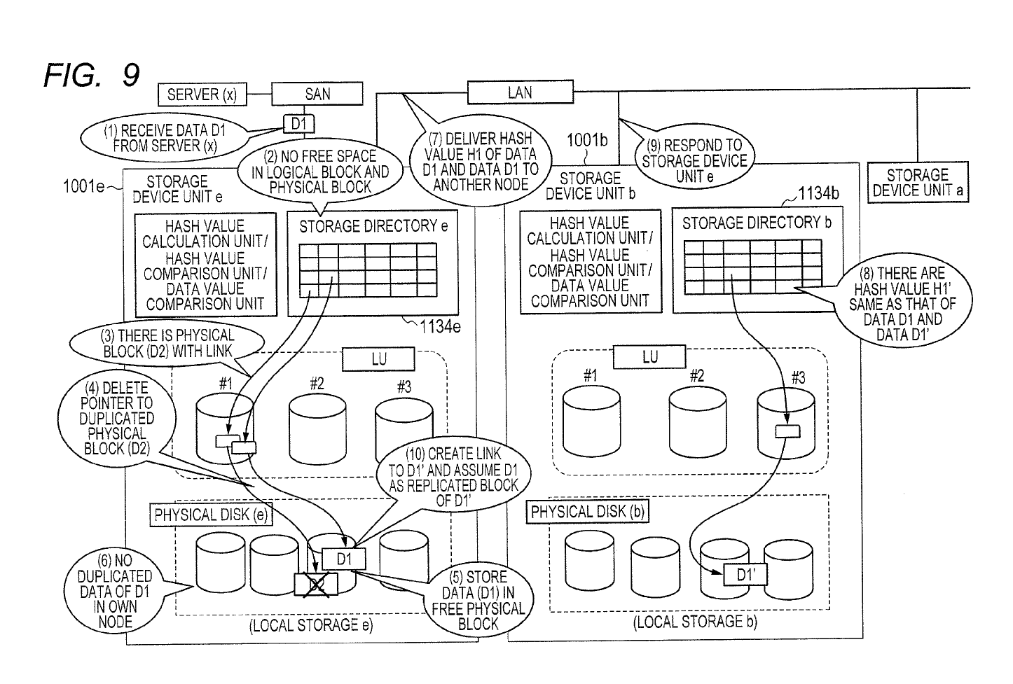

FIG. 9 illustrates data flows (1) to (7) performed between one storage device unit e and another storage device unit b, at the time of writing data, in a corresponding manner to Step 2000 to Step 2012 of the flow of FIG. 6. In this case, when “there is no free space” in the logical blocks of the storage directory e of the storage device unit 1001e, a duplicated physical block (D2) of the own node is deleted, and data D1 is stored in this free physical block. Because there are not blocks having the same data D1′ in the storage directory e of the own node, a hash value H1 is delivered to another node “b”.

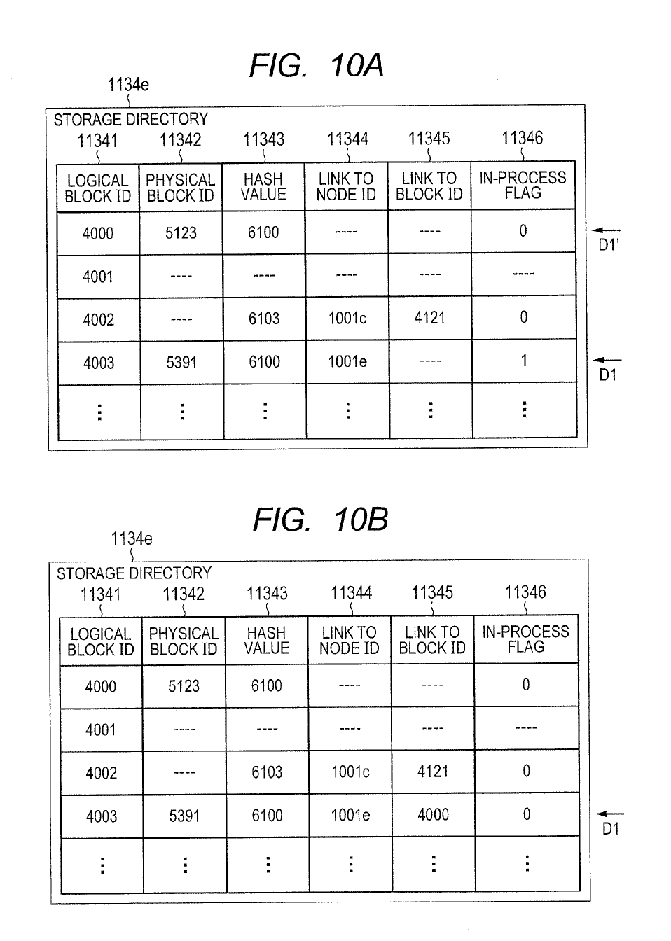

FIG. 10A illustrates an example in the storage directory 1134e, in which data is being written halfway. In this example, a hash value 6100 and data D1 of the logical block ID 4003 and a physical block ID 5391 of the own node are the same as a hash value 6100 and data D1′ of the logical block ID 4000 and a physical block 5123. A link 1001e to the logical block ID 4000 of the own node 1001e is set to the link 11344 to the node ID, and an “in-process flag” is set.

FIG. 9 illustrates data flows (8) to (11) performed between the storage device unit e and the storage device unit b, in a corresponding manner to Step 2013 to Step 2021 of the flow of FIG. 6. A link to the data D1′ of the storage device unit 1001b is created in the storage directory e, and the data D1 is assumed as a replicated block of the data D1′. That is, at least one entity of the same data portion included in different files is made to remain in the file system, the rest is kept in the form of replicated data, or a link corresponding thereto is created. The replicated data is data which has been marked as a target “to be prevented from being duplicated”. This allows improving the efficiency of the parallel process without increasing the total amount of data in the file system.

FIG. 10B illustrates an example of the storage directory 1134e, after data writing. A value “4000” is set to the link 11345 to the block ID, as a link to the logical block ID 4000 from the logical block ID 4003 of the own node, and the “in-process” flag is reset. “5123” and “5391” are set as IDs of the same data D1 and D1′, and represent that the same data items are duplicated and kept in different files of the storage device unit e.

In FIG. 6, when there are not nodes having the same hash value H1 or the same data (“NO” in S2013 and S2015), and when the ID of the own node is a large value (“NO” in S2017), the flow proceeds to Step 2020, in which the “in-process” flag is reset in the storage directory, and the process ends (S2021).

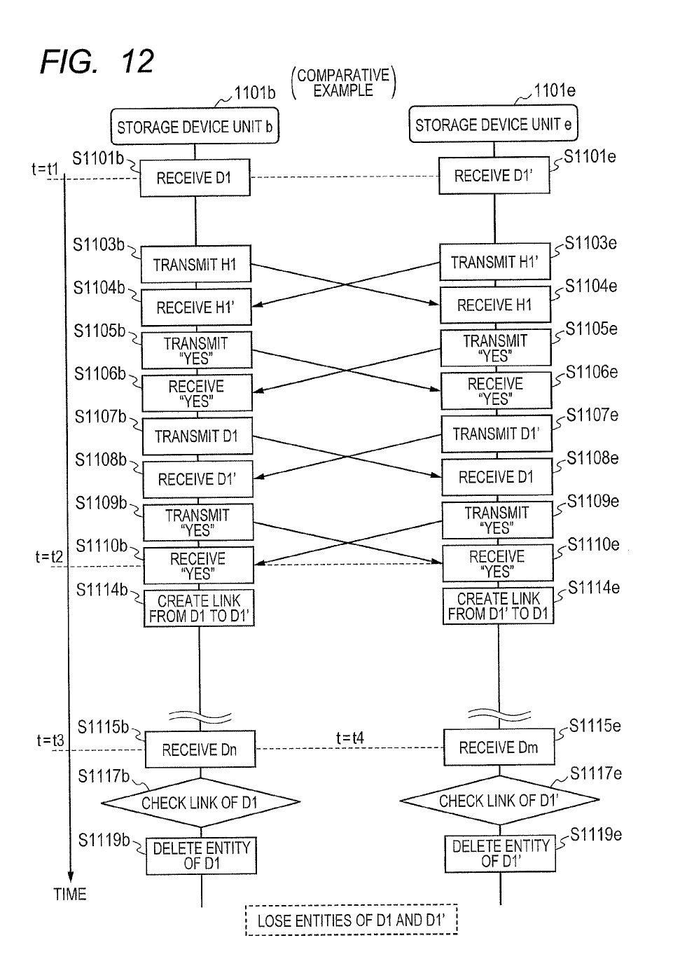

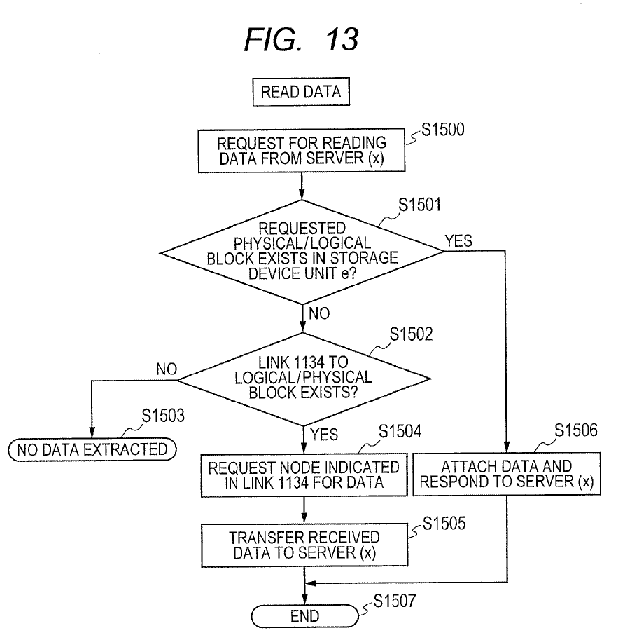

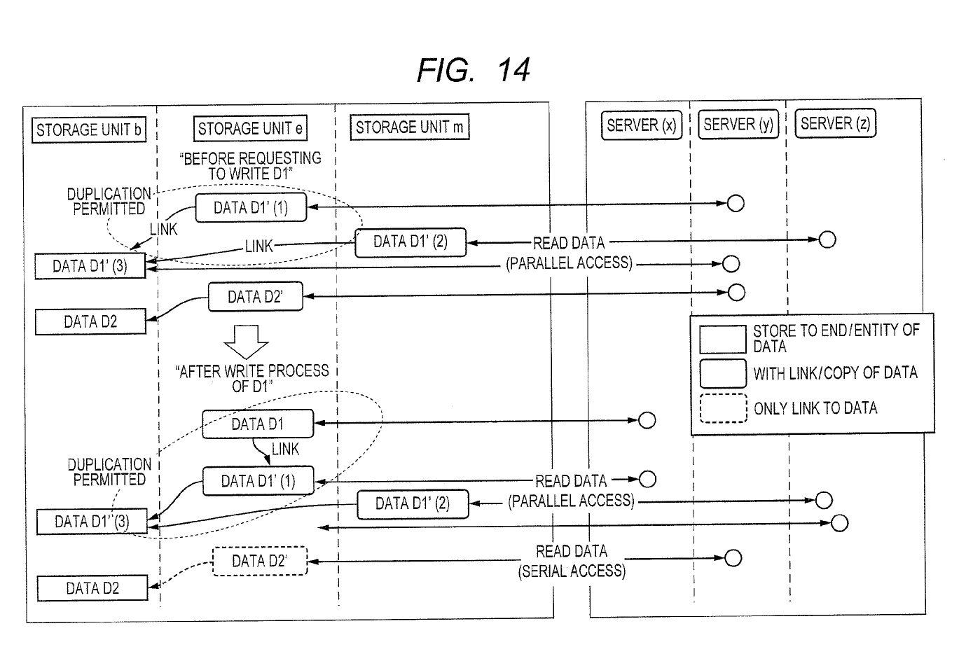

In Step 2017 of FIG. 6, when the “in-process” flag is set, a comparison is made on the magnitude relation between the ID of the own node and the ID of the node having sent the result. This comparison is made in order to prevent simultaneous deletion of the entities of the same data D1 and D1′. This will more specifically be described in FIG. 12 and FIG. 13.

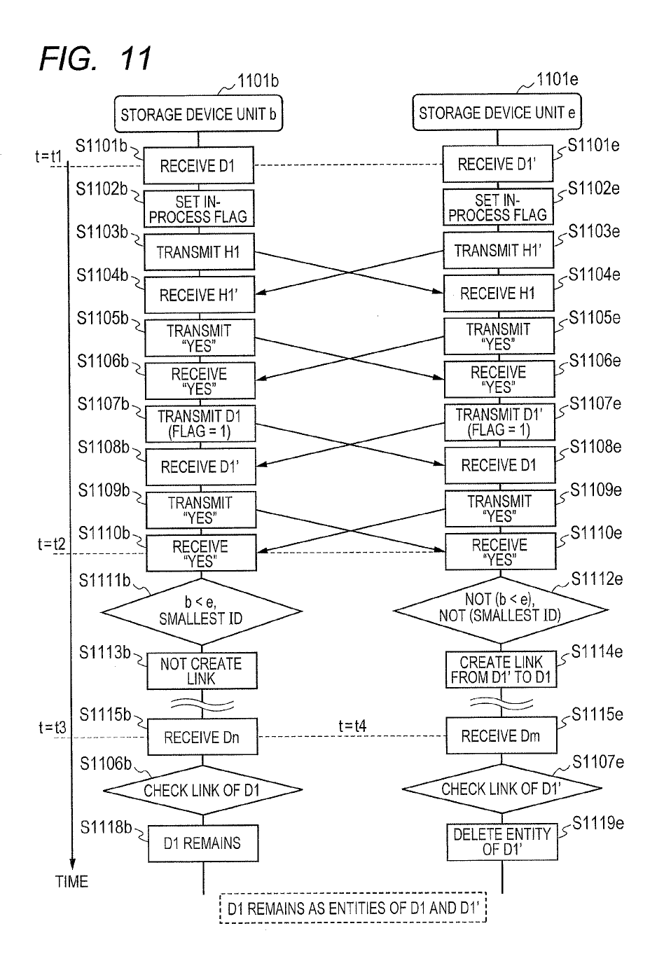

FIG. 11 is a diagram illustrating the data flow at the simultaneous process at the time of writing data in two storage device units when procedures from S2017 to S2019 of FIG. 6 are executed, that is, when there is a “function of keeping one real data item in a particular node, keeping one or more replicas in this particular node or another node, or creating a link”. Upon simultaneous (t=t1) reception of the written data D1 and D1′ from the server, by the storage device unit 1001b and the storage device unit 1001e, the same contents processes are parallelly performed from Step 1101 (b, e) to Step 1110 (b, e) of “t=t2”. Next, the storage device unit 1001b makes a comparison on the magnitude relation between nodes in Step 1111b. Because the value of the ID of the own node is smaller than that of the ID of the storage device unit 1001e (corresponding to “YES” in Step 2017 of FIG. 6), no link is created between data items in Step 1113b (corresponding to Step 2019 of FIG. 6). The storage device unit 1001e makes a comparison on the magnitude relation between nodes in Step 1112e. Because the value of the ID of the own node is larger than the value of the ID of the storage device unit 1001b, it is determined that the value is not smaller than the ID of the node which has sent the result (corresponding to “NO” of Step 2017 and “YES” of Step 2018 of FIG. 6), and a link from the data D1′ to the data D1 is created.

After this, in Step 1115 (b, e), the storage device unit 1001b receives written data Dn at “t=t3”, while the storage device unit 1001e receives written data Dm at “t=t4” from the servers. In a state where there is free space in the logical blocks and there is no free space in the physical blocks in the directory of the both storage device units (corresponding to “NO” in S2004 of FIG. 6), the storage device unit 1001b has no logical block having a link to the directory, and there is no link based on a check result of Step 1116b (corresponding to “NO” in S2005 of FIG. 6). Thus, there is “no free space” in the storage in Step 1118b, and no link is set up, resulting in ending the process. As a result, the data D1 remains as an entity together with the data Dn. The storage device unit 1001e has a logical block having a link to the directory (corresponding to “YES” in S2005 of FIG. 6), in Step 1117e. In Step 1119e, a link to the D1′ (corresponding to S2006 of FIG. 6) is deleted, and the data Dm is stored (corresponding to S2007 of FIG. 6). Thus, only the data Dm is kept. In this manner, in the file system, one data item D1 remains in the storage device unit 1001b as a particular node, as entities of D1 and D1′. In the storage device unit 1001e with a large ID value, a link from the data D1′ to D1 is created, and the entity of D1′ is deleted.

As a comparative example, FIG. 12 is a diagram illustrating the data flow at the simultaneous process, at the writing of data in two storage device units, when there is a “function of keeping one real data in a particular node, and keeping one or more replicas in this particular node or another node, or creating a link”, that is, when procedures from Step 2017 to 2019 of FIG. 6 are not performed. Upon simultaneous (t=t1) reception of the written data D1 and D1′ from the server, by the storage device unit 1001 and the storage device unit 1001e, the same contents processes are parallelly performed from Step 1101 (b, e) to “t=t2”, that is, Step 1109 (b, e). Further, in Step 1114 (b, e), a link from the data D1 to D1′ is created together with a link from the data D1′ to D1 (corresponding to Step 2019 of FIG. 6). After this, in Step 1115 (b, e), the storage device unit 1001b receives written data Dn at “t=t3”, while the storage device unit 1001e receives written data Dm at “t=t4” from each server. When there is free space in the logical blocks and there is no free space in the physical blocks in the directory of the both storage device units (corresponding to “NO” in S2004 of FIG. 6), the storage device unit 1001b and the storage device unit 1001e have a logical block having a link to the directory. As a result of checking in Step 1117 (b, e), there is a logical block having a link (corresponding to “YES” in S2005 of FIG. 6), a link between D1 and D1′ is deleted from the storage directory of the both in Step 1119 (b, e) (corresponding to S2006 of FIG. 6), and the data Dn and the data Dm are stored (corresponding to S2007 of FIG. 6). In this manner, entities of the data D1 and D1′ are simultaneously deleted from the file system (corresponding to S2006 of FIG. 6).

In the present invention, according to the “function of keeping one real data in a particular node, keeping one or more replicas in this particular node or another node, or creating a link”, when there are a plurality of data items with the same entities, only data of the particular node (for example, data of a small node ID) remains, thus preventing to simultaneously delete entities of data from the storage device units 1001. As a method for setting the particular node, the magnitude relation of ID values of the nodes may be set in the other way round, or the magnitude relation may be determined using a reference value (for example, an intermediate value) instead of the minimum ID value.

FIG. 13 is a flow chart illustrating a process for reading out data in one storage device unit. Upon reception of a request for reading out data D1 with a logical value p from the server (S1500), the storage device unit 1001e attaches data thereto, and transmits a response to the server (x), also when its own storage directory e has requested data with a logical value p (logical/physical blocks) (S1506). When its own storage directory e does not have the requested logical value p, and also when the storage directory e has the link 1134 to the logical value p (“YES” in S1502), the unit requests the storage device unit b as a destination link, to transfer data (S1504). The storage device unit 1001e receives data from the storage device unit b, transfers it to the server (x) (S1505), and the process ends (S1507). When there is no link 1134 to the logical value p (“NO” in S1502), the unit responds to the server (x) in accordance with determination that data of the requested logical value p has not been extracted, and the process ends (S1503).

Instead of performing the procedures from S1504 to S1506, when the storage directory e has the link 1134 corresponding to the logical value p (“YES” in S1502), the storage device unit 1001e may transmit a request to the storage device unit b as a destination link to transmit it from the storage device unit b directly to the server (x). The storage device unit b which has received this request may directly transmit the requested data to the server (x).

In this embodiment, when there is free space in the logical block of the directory, duplicate writing of the same data is permitted. Thus, it is possible to reduce the access time from the server (x) and to perform parallel access from a plurality of servers (x).

That is, when a plurality of servers transmit a request for reading/writing data to the storage device units connected through the plurality of access paths, each server can transmit a request for reading/writing data from/to another storage device unit, and each storage device unit can individually perform a process for requesting reading/writing of data. Thus, requests are not concentrated on one storage device unit, thereby allowing high-speed access to data.

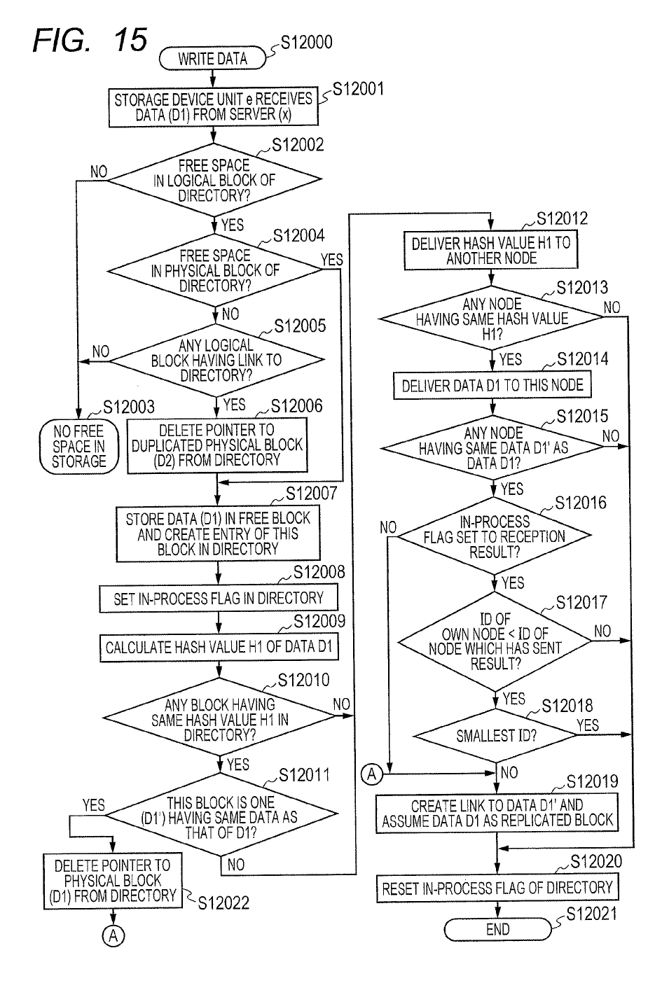

Descriptions will now be made to a process in a case where a plurality of servers perform accessing to one storage device unit in the file system of this embodiment, using FIG. 14. In this case, the mutual relation of the plurality of storage device units 1001b, 1001e, and 1001m will be described by way of example.

The upper stage of FIG. 14 corresponds to a state before receiving a request for writing data D1 from the server (x), while the lower stage of FIG. 14 corresponds to a state of FIG. 10B in which the request for writing the data D1 has been processed.

In the upper stage of FIG. 14, in the nodes 1001b, 1001e, and 1001m, the plurality of same data items D1′ (1) to D1′ (3) are duplicated and stored. That is, the real data D1′ (3) is stored in the particular node 1001b, while the replicated data D1′ (1) and D1′ (2) of the real data D1′ (3) are stored in the other nodes 1001e and 1001m. Real data D2 is stored in the particular node 1001b, and the replicated data D2′ with a set up link is stored in the node 1001e. In this state, it is possible to accept parallel access for the same data D1′ (1) to D1′ (3) and data D2 and D2′, from the plurality of servers.

In the lower stage of FIG. 14, in a state after the data D1 is written into the node 1001e, the plurality of same data items D1, D1′ (1) to D1′ (3) are duplicated and exist in the particular node 1001b and another nodes 1001e and 1001m. In the node 1001e, a link is set up from the replicated data D1 to the replicated data D1′ (1). For the data D2′, the replicated data D2′ is deleted, and only a link to the real data D2 of the particular node 1001b is recorded. In this state, it is possible to accept parallel access for the same data D1, D1′ (1) to D1′ (3), and the data D2, from the plurality of servers. For the data D2′, it is possible to accept serial access through a link. Accordingly, it is possible to increase an amount of stored data (different data items), while reducing the access time.

The data writing process is continuously performed by the “function of keeping one real data item in a particular node, and keeping one or more replicas in this particular node or another node, or creating a link”, in this embodiment. Then, in the end, one real data item D1, D2, . . . , DZ, and one or a plurality of replicated data items D1′, D2′, . . . , DZ′ are kept in the file system, and one link to each of these data is created. To evenly and efficiently store data in the storage device units and increase the amount of stored data (different data items) in the file system, it is necessary to function the duplicated data maintaining unit, that is, to prevent from a plurality of replicated data items from being kept in the particular node through the procedure after “YES” of Step 2018 of FIG. 6.

Accordingly, the file system of this embodiment permits that the same data is duplicated and exist in the own node or another node, and keeps other data with a set up link thereto, when there is free space in the logical block or physical block of the storage device unit 1001. That is, a plurality of same data entities and replicas are continuously kept in the file system without running out of storage capacity, and the contents located in the nearest position are read at the time of reading out data from the server, thereby enabling to reduce the access time and realize parallel access.

On the contrary, when there is no free space in the logical block and physical block of the storage device unit 1001, the file system prevents that a plurality of same data items exist in the same node or another node. As a result, the file system can realize reduction in the access time for arbitrary data from servers. That is, under the circumstances where it runs out of storage capacity to some extent, the “function of keeping one real data in a particular node, and keeping one or more replicas in this particular node or another node, or creating a link” is realized.

Accordingly, in the file system, the duplication degree of the same data is appropriately controlled, and it is possible to realize both the prevention of the excess duplication and parallel access.

### SECOND EMBODIMENT

Descriptions will now be made to an autonomous distributed type file system according to a second embodiment of the present invention. What differs from the first embodiment is that storage device units actively prevent the duplicate writing in their own nodes. It can be said that the “duplicate prevention” function of the first embodiment is a function of performing “duplicate prevention of another node”. A data maintaining unit of the second embodiment has a function of “duplicate prevention of own node” as described below, in addition to the function of “duplicate prevention of another node” of the first embodiment.

(1) If a server writes new data D into a logical position p (of logical/physical blocks), a storage device unit (in this example, 1001e) which has received data calculates a feature (hash value) H of the new data D, extracts data having the same hash value based on a list of feature values recorded in the own node, and sets up a link to data D′ if there is duplicated data D′ in its own node.

(2) The storage device unit 1001e reports the feature (hash value) H of the new data D to another storage device units i (hereinafter represented as a storage device unit 1001b) included in the storage system.

(Like the first embodiment, the function of “duplicate prevention of another node” is executed.)

(3) When it is about the time to delete data because it runs out of capacity, the storage device unit e deletes duplicated replicated data D′ of the own node.

FIG. 15 is a flow chart illustrating a process for writing data into one storage device unit in the second embodiment.

Procedures from Step 12000 to Step 12011 are the same as the procedures from Step 2000 to Step 2011 in the flow of the first embodiment. In Step 12011, when there are blocks having the same data D1′, replicated data D′ of the D1′ in the own node is deleted. That is, a pointer to the physical block in the storage directory e is deleted (S12022), and the process proceeds to Step 12018 thereafter. When there are no blocks having the same data in the storage directory of the own node, a hash value H1 is delivered to another node (S12012). The following procedures are the same as those of the flow of the first embodiment.

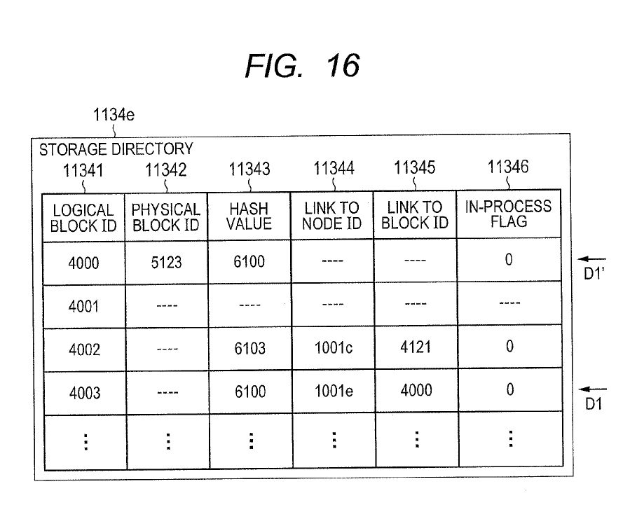

FIG. 16 is a diagram illustrating an example after data writing in the storage directory 1134e of the storage device unit 1001e, in the second embodiment. Unlike FIG. 10B, in the logical block ID 4003, a physical block ID is deleted. That is, it is indicated that an ID of data D1′ is deleted from the physical block ID 11342, and an entity of data D1 or a replica duplicated with the data D1′ is deleted in the storage device unit 1001e.

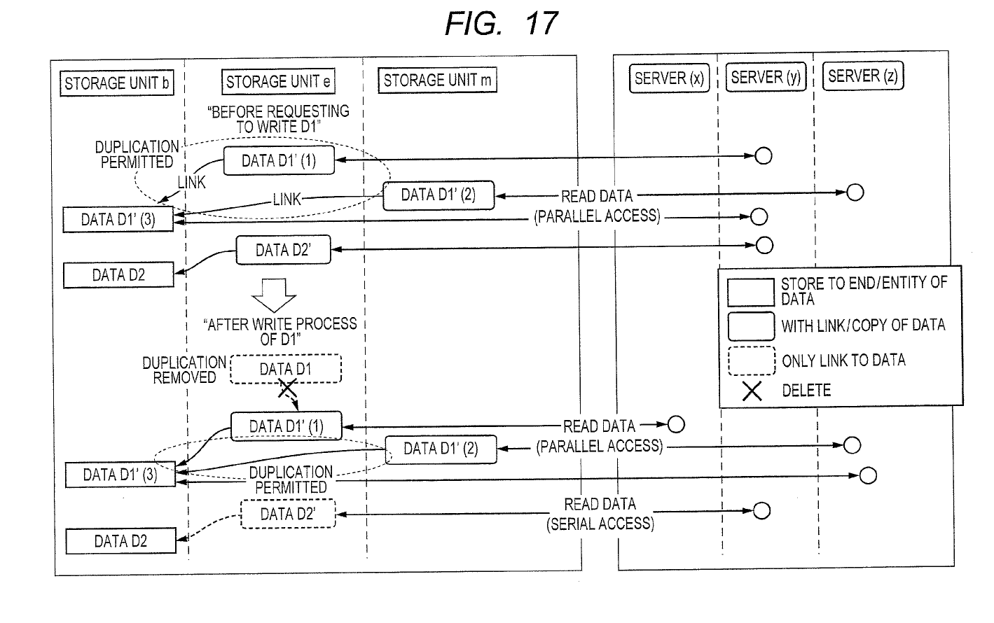

Descriptions will be made to accessing to one storage device unit from a plurality of servers, in the second embodiment, using FIG. 17. Like FIG. 14, what is given is an example of mutual relation of the plurality of storage device units 1001b, 1001e, and 1001m.

When there is free space in the physical block of the storage device unit 1001e, it is permitted that a plurality of same data items exist (for example, D1′) in the same node or another nodes 1001b or 1001m, and also a replica of data D2′ with a link set up thereto is kept. This is the same as the case of FIG. 14.

When there is no free space in the physical block of the storage device unit 1001e, it is prevented that a plurality of same data items exist in the same node or another node. For example, in the storage device unit 1001e, replicated data D2′ with a set up link to the data D2 of the storage device unit 1001b is deleted, and replicated data D1 duplicated with data D1′ (1) is deleted in the own node, also a link is set up from the data D1 to the data D1′ (1). The data D1′ (3) of the storage device unit 1001b (as a particular node) is kept as is as an entity. As a result, an attempt is made to reduce the time for access to arbitrary data (for example, the data D1 and the data D1′ (2) to D1′ (3)), without increasing the total amount of data.

In this embodiment, if the data writing process is continuously performed by the “function of keeping one real data in a particular node, and keeping one or more replicas in this particular node or another node, or creating a link” of the duplicated data maintaining unit, one real data items D1, D2, . . . , and DZ, and one replicated data items D1′, D2′, . . . , and DZ″ are kept in the file system, in the end, and one link to each of these data items is created. As a result, it is possible to increase an amount of stored data (different data) in the file system. When the use of the file system requires reduction in the access time, the duplicated data maintaining unit may function, in a manner that each node is permitted to keep two or three replicated data items in Step 12022 of FIG. 16.

Accordingly, in this embodiment, a plurality of same contents data items are continuously kept to an extent without running out of storage capacity. Under the circumstances where it about runs out of storage capacity, the “function of keeping one real data in a particular node, and keeping one or more replicas in this particular node or another node, or creating a link” is realized. Accordingly, in the file system, the duplication degree of the same data is appropriately controlled, and it is possible to realize both the prevention of the excess duplication and parallel access.

What is claimed is:

1. An autonomous distributed type file system which is connected to a data reference device through a first network, comprising:
a plurality of storage device units which are mutually connected through a second network and connected to the first network;
a storage directory; and
a duplicated data maintaining unit,
each of the storage device units includes a local storage,
wherein the storage directory has a function of keeping, in relation to data to be kept, an ID of a logical block and an ID of a physical block of the local storage of each of the storage device units, a value of a link to a node ID of a same or another storage device unit, and a value of a link to the logical block ID of this node ID, and
wherein the duplicated data maintaining unit refers to the storage directory, continuously keeps one real data item of the data and at least one replicated data item duplicately in a range without running out of storage capacity of each of the storage device units, and restricts or prevents writing of the replicated data when there is no free space in the storage capacity.

2. The autonomous distributed type file system according to claim 1,
wherein each of nodes included in each of the storage device units is assigned a value of a unique node ID in advance, and the node having a particular node ID is set as a particular node, and
wherein the duplicated data maintaining unit keeps one real data item in the particular node, keeps at least one replica thereof in this particular node or any of the other nodes, or creates a link thereto, in relation to any of the nodes, when there is no free space in the storage capacity of this node.

3. The autonomous distributed type file system according to claim 2,
wherein the duplicated data maintaining unit permits duplicate writing of data with same contents when there is free space in the logical block of the local storage of an own node in any of the storage device units, and deletes a pointer to the duplicated physical block of the own node or any of the other nodes from the storage directory and prevents duplicate writing of the data with the same contents when there is no free space in the logical block.

4. The autonomous distributed type file system according to claim 2,
wherein each of the storage device units includes a storage interface and a local controller,
wherein the local controller has functions of the storage directory and the duplicated data maintaining unit,
wherein the duplicated data maintaining unit:
refers to the storage directory of an own node,
permits duplicate writing of the data with the same contents when there is free space in the logical block of the local storage of the own node, and
deletes a pointer to the duplicated physical block of the own node or any of the other nodes from the storage directory and prevents duplicate writing of the data with the same contents when there is no free space in the logical block.

5. The autonomous distributed type file system according to claim 4,
wherein the duplicated data maintaining unit:
refers to the storage directory of the own node, in response to a request for writing data from the data reference device,
permits duplicate writing of the data with the same contents when there is free space in the logical block of the local storage,
deletes a pointer to the duplicated physical block from the storage directory, ensures a free block, and stores the requested data in this free block when there is no free space in the logical block,
leaves one real data item in the particular node, sets up a link to another same data item, and prevents duplicate writing of the real data, when same data as the data is in different files of the own node or any of the other nodes, and
updates a value of the storage directory.

6. The autonomous distributed type file system according to claim 5,
wherein the storage directory has a function of keeping a hash value of the data and a function of keeping a value of an in-process flag representing whether the node is in an in-process state,
wherein the local controller:
checks whether same data is in the own node or any of the other nodes, using the hash value, and
notifies any of the other nodes that same data as the data of the own node is in any of the other nodes, using the in-process flag.

7. The autonomous distributed type file system according to claim 2,
wherein the autonomous distributed type file system has a plurality of servers as the data reference device, which are connected to the plurality of autonomous distributed type storage device units, through the first network,
each of the first network and the second network is configured with an SAN, LAN, or WAN, and
the local controller has a management terminal, and controls the local storage in accordance with a command received from any of the servers.

8. The autonomous distributed type file system according to claim 2, further comprising:
a management server which is connected to the first and the second network,
wherein the management server:
includes a function of the storage directory and a function of the duplicated data maintaining unit,
keeps a logical position in the storage device unit, the data and a feature quantity at the time of writing data, and
refers to the storage directory to acquire positional information of the storage device unit having the data at the time of out reading the data from the data reference device.

9. The autonomous distributed type file system according to claim 8,
wherein when there is no free space in the storage capacity of a first storage device unit, the duplicated data maintaining unit:
based on a comparison result of IDs of nodes of the storage device units, remains the real data of the particular node, sets up a link to the another same data, and prevents duplicate writing of the real data when same data as the data is in the first storage device unit or another storage device unit.

10. A storage device unit included in an autonomous distributed type file system, comprising:
a local storage; and
a local controller,
the local controller includes a storage directory and a duplicated data maintaining unit,
wherein the storage directory has a function of keeping, in relation to data to be kept, an ID of a logical block and an ID of a physical block of the local storage of each of the storage device units, a value of a link to a node ID of a same or another storage device unit, and a value of a link to the logical block ID of this node ID, and
wherein the duplicated data maintaining unit:
refers to the storage directory,
continuously keeps one real data item of the data and at least one replicated data item duplicately in a range without running out of storage capacity of the local storage, and
restricts or prevents writing of the replicated data when there is no free space in the storage capacity.

11. The storage device unit according to claim 10,
wherein the duplicated data maintaining unit:
refers to the storage directory of an own node, in response to a request for writing data from the data reference device,
permits duplicate writing of data with same contents, when there is free space in the logical block of the local storage,
deletes a pointer to the duplicated physical block from the storage directory, ensures a free block, and stores the requested data in this free block when there is no free space in the logical block,
leaves one real data item, sets up a link to another same data item, and prevents duplicate writing of the real data when same data as the data is in different files of the own node or any of other nodes, and
updates a value of the storage directory.

12. A data access method for an autonomous distributed type file system,
wherein the autonomous distributed type file system is a file system which has a plurality of servers, as a data reference device, which are connected through a plurality of access paths, and in which each of the access paths is connected to a plurality of storage device units,
each of the storage device units includes a storage interface, a local controller, and a local storage,
wherein the local controller includes a storage directory which is a table for managing writing or readout of data to or from the storage device unit of an own node, in accordance with free space in a capacity of the storage device unit, the method comprising the steps of:
receiving a request for writing data from the server,
referring to the storage directory, and continuously keeping one real data item of the data and at least one replicated data item duplicately in a range without running out of storage capacity of the own node, and
restricting or preventing writing of the replicated data, when there is no free space in the storage capacity.

13. The data access method according to claim 12,
wherein each node included in the storage device unit is assigned a value of a unique node ID in advance, and the node having a particular node ID is set as a particular node, the method further comprising the steps of:
keeping, in relation to any of the nodes, one real data item in the particular node, keeping at least one replica in the particular node or any of the other nodes, or creating a link when there is no free space in the storage capacity of this node.

14. The data access method according to claim 13, wherein a procedure for accessing data of the file system includes the steps of:
requesting a first storage device unit to read write, from the server;
transferring the data to the server when this requested data is in the first storage device unit which has received the request for reading the data;
searching for existence of a link to same data when the requested data is not in the first storage device unit which has received the request for reading the data;
requesting a second storage device unit as a destination link to transfer the data to the first storage device unit, when the link is set up;
transmitting the requested data to the first storage device unit, in the second storage device unit which has received the request from the first storage device unit; and
transmitting, to the server, the data which has been received by the first storage device unit having received the data from the second storage device unit.

15. The data access method according to claim 13, wherein a procedure for accessing to data of the file system includes the steps of:
requesting the first storage device unit to read data from the server;
transferring the requested data to the server when the requested data is in the first storage device unit which has received the request for reading the data;
searching for existence of a link to same data when the requested data is not in the first storage device unit which has received the request for reading the data;
requesting a second storage device unit as the destination link to transfer the data to the first storage device unit when the link is set up; and
transmitting the requested data to the server, in the second storage device unit which has received the request from the first storage device unit.
